(19) United States
(12) Patent Application Publication
(10) Pub. No.: US 2006/0239128 A1
(43) Pub. Date: Oct. 26, 2006

(54) Device and method for writing data to a digital medium

(75) Inventor: David Pettigrew, Corvallis, OR (US)

Correspondence Address: HEWLETT-PACKARD COMPANY;Intellectual Property Administration, P.O. Box 272400, Fort Collins, CO, 80527-2400, US

(73) Assignee: Hewlett-Packard Development Company, L.P

(21) Appl. No.: 11/114,782

(22) Filed: Apr. 25, 2005

(51) Int. Cl. H04B 1/20

(52) U.S. Cl. 369/1

(57) ABSTRACT

Systems and methods for writing data to a digital medium are disclosed. The method includes receiving data from a source, the data including primary content and advertising content unrelated to the primary content, writing the primary content to a data portion of a digital medium, and writing at least a portion of the advertising content to a labeling layer of the digital medium

### BACKGROUND OF THE INVENTION

The present invention relates generally to the field of media labeling. In particular, the invention relates to methods and systems for labeling digital media with advertising content.

Digital video recorders are devices that are able to record and play audio or video content from satellite, cable or broadcast television. Digital video recorders may make use of a hard drive to record such content. However, other types of digital media have become increasingly popular for recording, storing and playing back the content. For example, digital media, such as compact discs (CDs) or digital versatile discs (DVDs), are a popular form of storage media. Recently, writable digital media have become increasingly popular among users and can be used for storing audio and video content.

Many digital video recorders are provided with the ability to extract and delete advertisements from the broadcast content. For example, commercials interspersed throughout a broadcast television program may be deleted or skipped by the digital video recorder during either recording or playback in order to improve the continuity of the program. As this practice becomes increasingly prevalent, the loss to advertisers and broadcasters may cause harm to the industry in general, which could, in turn, adversely impact consumers by increasing the cost or reducing the availability of program content to consumers.

### SUMMARY OF THE INVENTION

One embodiment of the invention relates to a method of writing data to a digital medium. The method includes receiving data from a source, the data including primary content and advertising content unrelated to the primary content, writing the primary content to a data portion of a digital medium, and writing at least a portion of the advertising content to a labeling layer of the digital medium.

It is to be understood that both the foregoing general description and the following detailed description are exemplary and exemplary only, and are not restrictive of the invention as claimed.

### BRIEF DESCRIPTION OF THE DRAWINGS

FIG. 1 is a schematic illustration of a system implementing an embodiment of the invention;

FIG. 2 is a schematic illustration of an embodiment of a digital media device according to an embodiment of the invention;

FIG. 3A is a top plan view of an exemplary digital medium;

FIG. 3B is a cross-sectional view of the exemplary digital medium of FIG. 3A;

FIG. 4 is a schematic illustration of an embodiment of a digital media drive according to an embodiment of the invention;

FIG. 5 is a schematic illustration of another embodiment of a digital media drive according to an embodiment of the invention; and

FIG. 6 is a flow chart illustrating an embodiment of a method of writing content to a digital medium according to an embodiment of the invention.

### DETAILED DESCRIPTION OF CERTAIN EMBODIMENTS

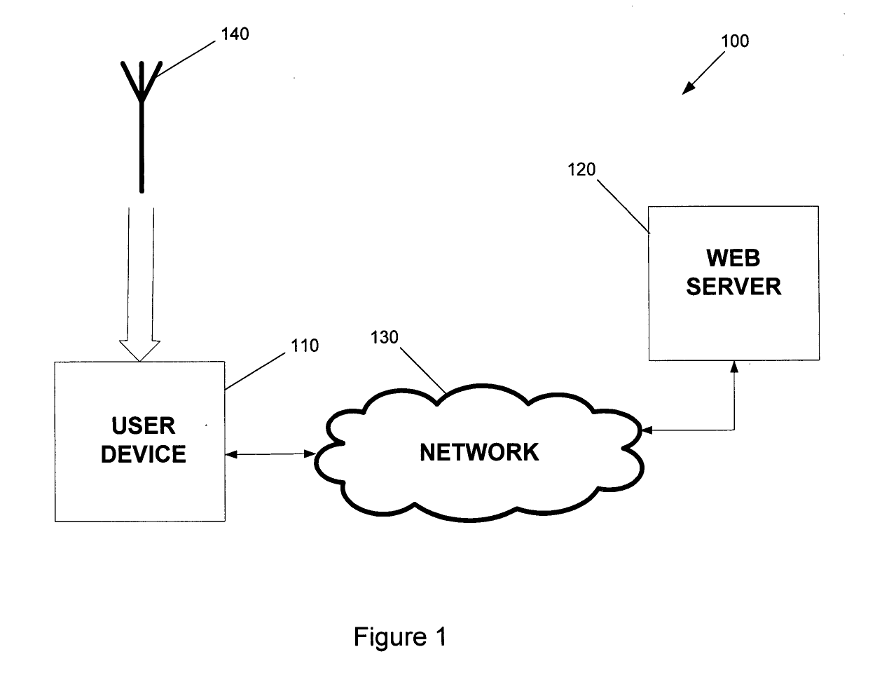

Referring to FIG. 1, a schematic illustration of an exemplary system implementing embodiments of the invention is provided. The system 100 includes a digital media device 110 adapted to receive data from one or more sources. The digital media device 110 may also be a digital video recorder, a personal computer or other device adapted to receive data.

The digital media device 110 may receive data broadcast by an over-the-air broadcaster 140 as radio-frequency signals. The data may also be received from a server 120 through a communication network 130, such as the Internet. In this regard, the data may be received as streamed video and/or audio data from a server on the Internet. In other embodiments, the data may be downloaded from the web server 120 by the digital media device 110.

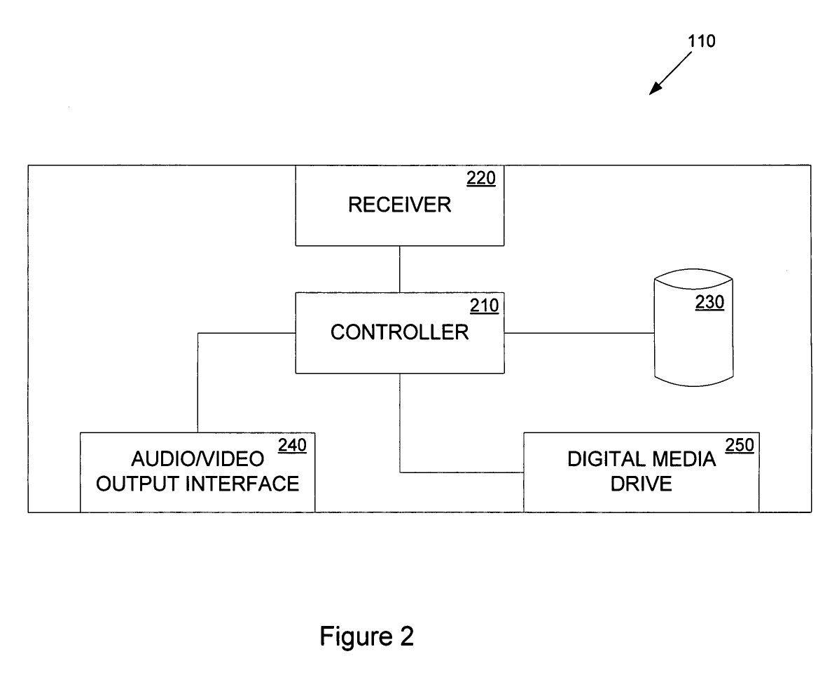

FIG. 2 is a schematic illustration of an embodiment of a digital media device. As noted above, the digital media device 110 may be a digital video recorder, a personal computer or any other device capable of receiving data from a source such as an over-the-air broadcaster or a web server. In this regard, the embodiment of the digital media device 110 illustrated in FIG. 2 is provided with a receiver module 220 adapted to facilitate communication with the source. In a digital video recorder, for example, the receiver may include inputs for receiving data through an antenna, a cable or a satellite dish.

The digital media device 110 also includes a controller 210 adapted to decode data for recording or playback. The controller 210 may be adapted to communicate with various components of the digital media device 110, including the receiver module 220, a memory device 230 such as a hard disk, an output interface 240 and a digital media drive 250.

Upon receiving the data from the source, the controller 210 may analyze or process the data. The processing of the data may be determined according to user input, indication by the source or a pre-determined algorithm implemented in the controller 210. In one embodiment, a user may provide input to the digital media device 110 directing the controller 210 to either playback the data or to store the data in the memory device 230 or a removable storage media, such as a DVD+RW disc, in the digital media drive 250. Further, the controller 210 may be adapted to determine whether the data from the source includes any advertising content. In this regard, the data may include advertising content overlaid or interleaved with the primary content. The presence of the advertising content may be indicated within a header packet of the streamed data, for example. As described below, advertising content embedded in the data may be extracted for printing onto a labeling layer of a digital medium.

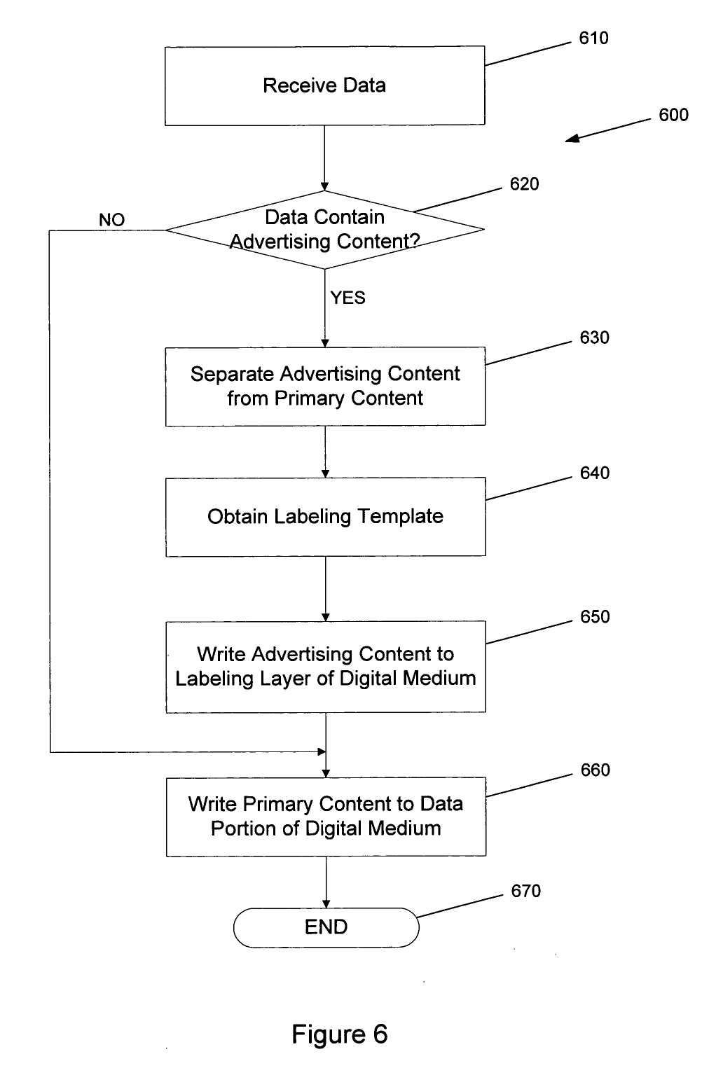

The memory device 230 may be provided with pre-stored templates to facilitate labeling digital media. In this regard, the templates may correspond to a specific media type, such as CD or DVD. For example, a template may be in the form of a surface of a disk and may allocate regions of the template for printing of various information, including advertisements as described below with reference to FIG. 6.

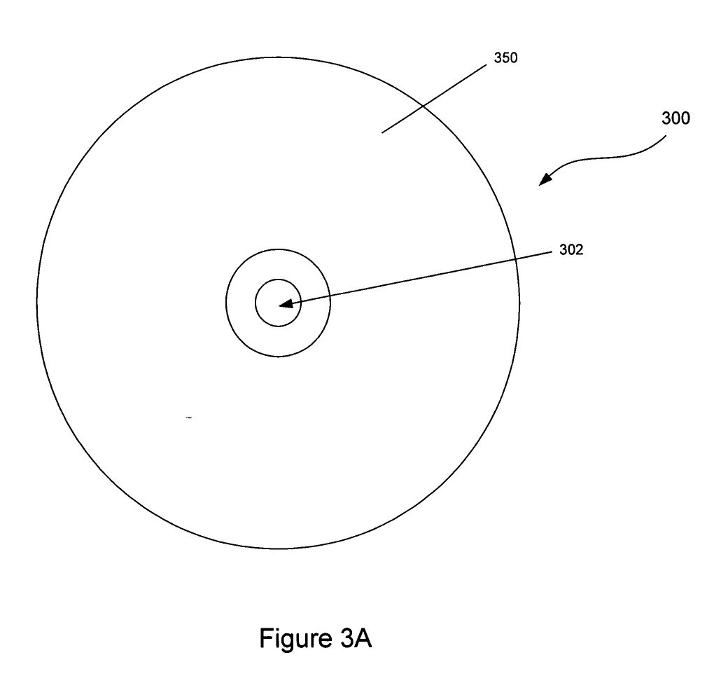

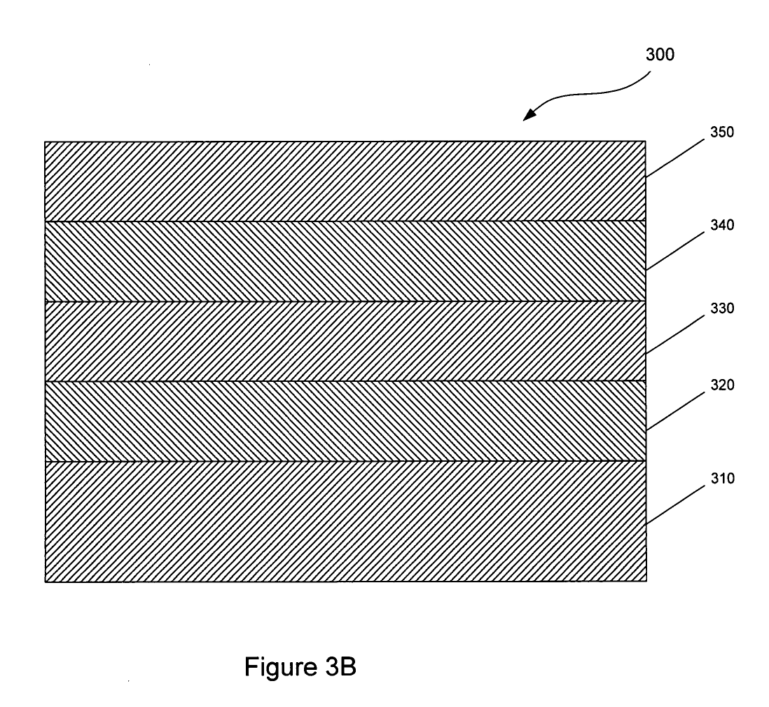

Referring now to FIG. 3A, an exemplary digital medium for use with the digital media drive 250 of FIG. 2 is illustrated. The digital medium 300 may be an optical medium adapted to record and store digital information. The digital medium 300 may be a compact disc (CD), a digital video disc (DVD), a CD, a CD-R, a CD+R, a CD-RW, a CD+RW, a DVD, a DVD-R, a DVD-RAM, a DVD-RW, a DVD+RW, a DVD+R, a HD-DVD or a Blu-ray disc (BD), for example.

The digital medium 300 includes a labeling layer 350 on one surface. One such labeling layer 350 includes a layer of laser-sensitive film on a disc and is described in U.S. Patent Application Publication No. 2003/0108708 A1. The energy in a laser causes the laser-sensitive film to change color, thereby producing an optically visible image. The digital medium 300 is provided with a central opening 302 for mounting the digital medium 300 onto a digital media drive, for example.

In a particular embodiment, the laser can activate the laser-sensitive film, which may be arranged as a single spiral track or a plurality of circular tracks, similar to the arrangement of digital data on a digital medium. Each track may be approximately 20 microns wide, for example.

Referring now to FIG. 3B, a cross-sectional view of one embodiment of digital medium 300 of FIG. 3A is illustrated. The medium 300 includes a substrate layer 310, which in one embodiment may be 1.2 mm thick and may be made of a laser-transparent material such as polycarbonate or glass, for example. A data layer 320 is provided on the substrate layer 310 upon which digital data may be written and stored. The data layer 320 may be formed of, for example, a UV light-cured layer of acrylate. In alternate embodiments, the data layer 320 may be one or more grooved tracks formed on the substrate itself. The data can then be read from the data layer 320 using a laser. As is well understood by those skilled in the art, a laser generally penetrates through the substrate layer 310 to read from or write to the data layer 320.

A protective layer 330 is provided to protect the data layer 320. The protective layer 330 may be, for example, an aluminum or gold reflective layer. A thin layer of clear lacquer 340, such as acrylic, is provided for further protection. The lacquer layer 340 may have a thickness of approximately four microns. A thin labeling film (approximately 8 microns thick) of a laser-sensitive material forming the labeling layer 350 is positioned on the lacquer layer 340. The thickness and materials of these layers 310, 320, 330, 340, 350 is not limiting on the present invention. In one embodiment, the laser is positioned adjacent labeling layer 350 when labeling the medium 300.

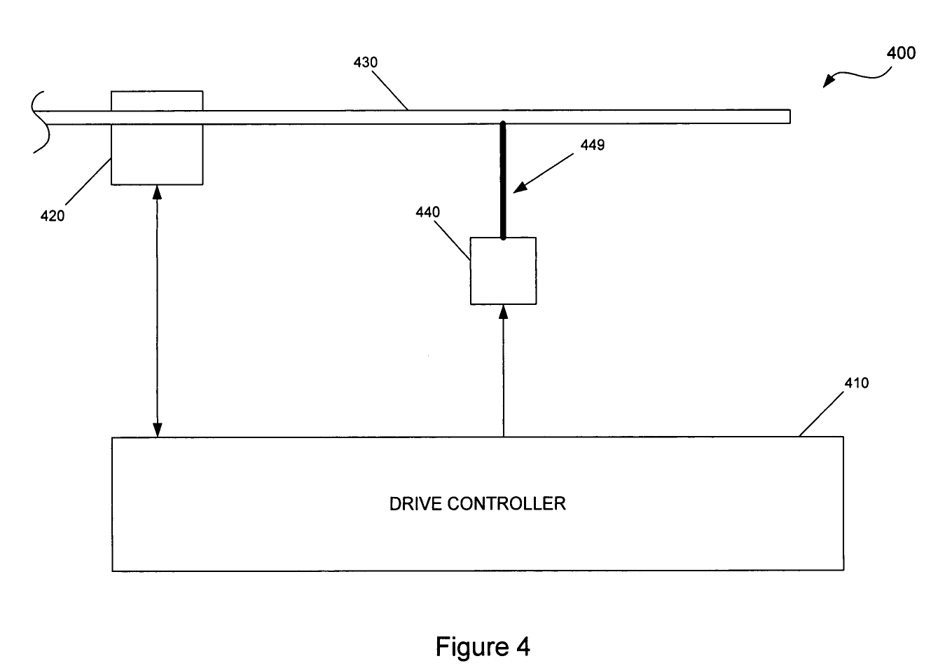

FIG. 4 illustrates a schematic illustration of an embodiment of a digital media drive. The digital media drive 400 includes a drive controller 410 adapted to control a spindle motor 420 of the digital media drive 400. In this regard, the drive controller 410 may include a motor-drive sub-module. The spindle causes a digital medium 430 mounted thereon to spin, exposing the various regions of the digital medium 430 to a laser beam 449 from an optical module 440. The optical module 440 may include various components, including a laser module, a prism and a sensor module. The optical module 440 may include a laser adapted to generate the appropriate laser energy. In the illustrated embodiment of the digital media drive 400, the same optical module 440 may be adapted for writing and reading data from the digital medium, as well as for providing laser energy for the labeling layer. Thus, content may be written to the data layer of the digital medium 430 and to the labeling layer sequentially by flipping the digital medium over in the drive 400. Further, the optical module 440 may be configured for a specific digital medium, such as a CD or a DVD.

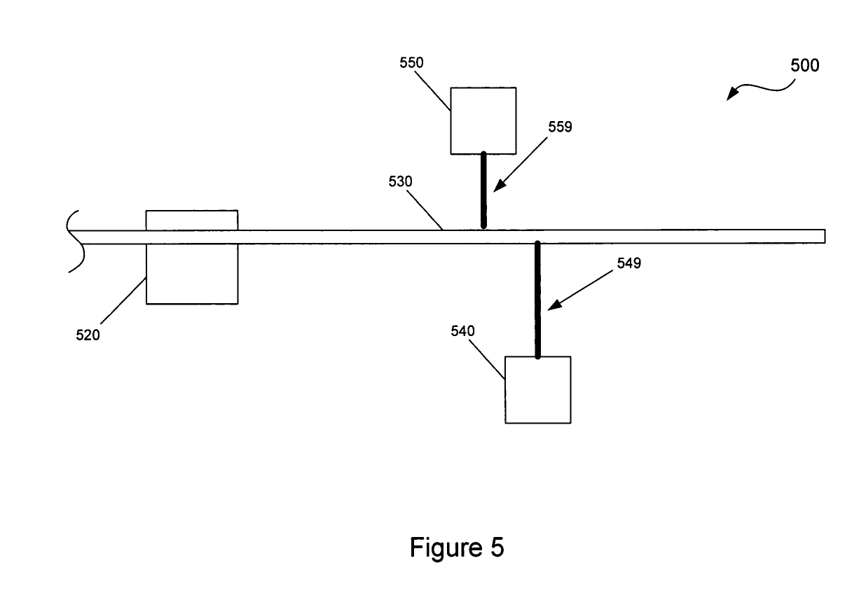

FIG. 5 illustrates a schematic illustration of another embodiment of a digital media drive. The digital media drive 500 is similar to the digital media drive 400 of FIG. 4 and includes a spindle motor 520 for causing a digital medium 530 mounted thereon to spin. The digital media drive of FIG. 5 includes two optical modules 540, 550. Each optical module 540, 550 is adapted to produce a laser beam 549, 559, respectively, for writing to the digital medium 530. The optical modules 540, 550 are positioned on opposite sides of the digital medium. Thus, while one optical module 540 writes data to the data portion of the digital medium 530, the other optical module 540 may write to the labeling layer of the digital medium 530. In this regard, both data and the label may be written substantially simultaneously.

Referring now to FIG. 6, an embodiment of a process of writing content to a digital medium is illustrated. The process 600 may be implemented within a controller or a digital media device. The process 600 begins with the receiving of data 610 from a source (block 610). As noted above, the data may be received from a variety of sources, including over-the-air broadcasters, cable, satellite or web servers. The data received may include primary content and advertising content. Primary content includes the program which the user may wish to have played back or recorded for later playback. The program may include, for example, audio or video data, as well as other types of data including software or shareware relating to, for example, a video game. Advertising content may include audio, video, text, graphic or other data interspersed throughout the program or placed at other positions within the program. As described above, in various embodiments, the advertising content may be embedded, overlaid or interleaved with the primary content.

At block 620, a determination is made as to whether the data received from the source includes an advertising content. If the data does not include any advertising content, the process 600 proceeds to block 660. On the other hand, if the data does include advertising content, the process 600 proceeds to block 630.

At block 630, the advertising content and the primary content are separated. This may be achieved in a variety of manners. For example, in one embodiment, streaming data may include a header block for each packet of streamed data indicating whether the data in the packet is primary content or advertising content. A value in the header block of the data packet may be used to determine whether the data packet includes advertising content or primary content. In another embodiment, the primary content may be separated from print files containing the advertising content according to systems and methods described in U.S. patent application Ser. No. 10/628,902, filed Jul. 28, 2003, titled “System and Method for Distinguishing Between Data and Print Files in an Archived File.” For example, a “manifest” file may be generated and included with the data received from the source. A manifest file is a type of metadata that assigns the primary content and the advertising content identifiable locations within the data received from the source. In other words, the manifest file or the metadata provides the primary content and advertising content paths along with their format information. The metadata or the information in the manifest file may be used to automatically determine which portions of the data include primary content and which portions include advertising content. With the primary content and the advertising content separated, the process 600 proceeds to block 640 and obtains a labeling template for printing of advertising content to the labeling layer of the digital medium.

The advertising content contained in the data may be in the form of audio and/or video data. The data may contain corresponding graphical or text data suitable for printing onto a labeling layer. For example, an audio/video advertisement for an automobile may have a corresponding printable advertisement embedded within the data received from the source. Alternatively, the data from the source may include instructions to retrieve the printable advertising content from another source, such as another web server.

Advertising content, as used herein, refers to content that is unrelated to the primary content. In this regard, the advertising content may be indicative of an advertisement for a product, a service, another program or another episode of the program in the primary content, for example. Further, as unrelated to the primary content, the advertising content may be different for the same primary content downloaded by or streamed to different individuals or locations, or for the same individuals or locations but at different times.

Similarly, the data may include instructions to retrieve a labeling template for printing of the advertising content. The instructions may indicate a standardized template stored within the digital media device or a template to be retrieved from another source. In this regard, one or more labeling templates may be stored in a local storage device, such as the memory device 230 of the digital media device 110 shown in FIG. 2. A standardized set may be provided with the digital media device 110, and the instructions may indicate a specific template from the standardized set. In another embodiment, the instructions may indicate a specific template to be used which may be located on, for example, a remote server. The instructions may cause the digital media device to access the remote server and download the template to be used. Each labeling template may dictate the positioning, font and other characteristics of labeling content, such as the advertising content.

At block 650, the printable advertising content is written to the labeling layer of the digital medium. Other information, such as the title of the primary content, or the program, may also be printed according to the template.

At block 660, the primary content is written to the data portion of the digital medium. As described above, in the case of a CD or DVD, the primary content may be written to the data portion using an optical module adapted to generate a laser beam.

Although the flow chart of FIG. 6 illustrates the primary content being written after the advertising content, printing of the primary content and the advertising content in a different order or substantially simultaneously is also contemplated.

Thus, the user is provided with a convenient way of recording or storing a program without advertisements, while advertisers are provided with an outlet for the advertisements.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. A method of writing data to a digital medium, comprising:
a) receiving data from a source, the data including primary content and advertising content unrelated to the primary content;
b) writing the primary content to a data portion of a digital medium; and
c) writing at least a portion of the advertising content to a labeling layer of the digital medium.

2. The method according to claim 1, further comprising:
extracting the advertising content from the data received from the source.

3. The method according to claim 1, further comprising:
extracting the primary content from the data received from the source.

4. The method according to claim 1, further comprising:
separating the primary content and the advertising content in the data received from the source.

5. The method according to claim 4, wherein the separating includes using a value in a header block of a data packet to determine whether the data packet includes advertising content or primary content.

6. The method according to claim 4, wherein the separating includes using metadata to identify advertising content and primary content.

7. The method according to claim 1, wherein the digital medium is one of a CD, a CD-R, a CD+R, a CD-RW, a CD+RW, a DVD, a DVD-R, DVD-RAM, DVD-RW, DVD+RW, a DVD+R, a HD-DVD and BD.

8. The method according to claim 7, wherein the labeling layer includes a laser-sensitive film positioned on a surface of the digital medium.

9. The method according to claim 1, wherein receiving data from a source includes downloading content from a server through a communication network.

10. The method according to claim 1, wherein receiving data from a source includes receiving streamed content.

11. The method according to claim 1, wherein receiving data from a source includes receiving broadcast content.

12. The method according to claim 11, wherein receiving broadcast content includes receiving radio frequency transmissions.

13. The method according to claim 11, wherein receiving broadcast content includes receiving data streamed from a server through a communication network.

14. The method according to claim 1, wherein the primary content includes at least one of video data and audio data.

15. The method according to claim 1, wherein the advertising content includes at least one of text and graphics.

16. The method according to claim 1, wherein steps b) and c) are performed sequentially.

17. The method according to claim 1, wherein steps b) and c) are performed substantially simultaneously.

18. The method according to claim 1, wherein step c) includes writing the advertising content on segments of the labeling layer according to a template.

19. The method according to claim 18, wherein the template is accessed from a local storage device.

20. The method according to claim 18, wherein the template is accessed from a remote server.

21. A device for writing data to a digital medium, comprising:
a receiver adapted to receive data from a source, the data including primary content and advertising content; and
a digital media drive adapted to write the primary content to a data portion of a digital medium and to write at least a portion of the advertising content to a labeling layer of the digital medium.

22. A system for writing data to a digital medium, comprising:
means for receiving data from a source, the data including primary content and advertising content;
means for writing the primary content to a data portion of a digital medium; and
means for writing at least a portion of the advertising content to a labeling layer of the digital medium.

23. A program product, comprising machine readable program code for causing a machine to perform the following method steps:
writing primary content of data received from a source to a data portion of a digital medium; and
writing at least a portion of advertising content of the data received from the source to a labeling layer of the digital medium.

24. A method of writing data to a digital medium, comprising:
a) receiving data from a source, the data including primary content and labeling content;
b) retrieving a labeling template; and
c) printing at least a portion of the labeling content in accordance with the labeling template on a labeling layer of the digital medium.

25. The method according to claim 24, wherein step b) includes retrieving the labeling template from a local storage device.

26. The method according to claim 24, wherein step b) includes retrieving the labeling template from a remote server.

27. A device for writing data to a digital medium, comprising:
a receiver adapted to receive data from a source, the data including primary content and labeling content; and
a digital media drive adapted to print at least a portion of the labeling content in accordance with the labeling template on a labeling layer of the digital medium.
